(19) United States
(12) Patent Application Publication
(10) Pub. No.: US 2010/0002341 A1
(43) Pub. Date: Jan. 7, 2010

(54) MAGNETIC HEAD SLIDER AND MAGNETIC DISK APPARATUS

(75) Inventors: Tohru Fujimaki, Kawasaki (JP); Takahiro Imamura, Kawasaki (JP); Akihide Jinzenji, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/491,757

(22) Filed: Jun. 25, 2009

(30) Foreign Application Priority Data
Jul. 3, 2008 (JP) 2008-175076

(51) Int. Cl. G11B 5/60

(52) U.S. Cl. 360/236.6; G9B/5.229

(57) ABSTRACT

A magnetic disk apparatus includes a magnetic recording medium that records information, a magnetic head slider flying over a surface of the magnetic recording medium to read or write information from or to the magnetic recording medium, a rear rail having a rear ABS and a rear stepped bearing surface on an air outflow side from which air flows out from the magnetic head slider, the rear stepped bearing surface being deeper than the rear ABS, and at least one closed vibration attenuation groove that is formed on the rear ABS of the rear rail with a depth greater than the rear ABS and has the rear stepped bearing surface on an air inflow side.

### CROSS-REFERENCE TO RELATED APPLICATION

This application is based upon and claims the benefit of priority of the prior Japanese Patent Application No. 2008-175076, filed on Jul. 3, 2008, the entire contents of which are incorporated herein by reference.

### FIELD

The embodiments discussed herein are directed to a magnetic head slider and a magnetic disk apparatus that read or write information by flying over a surface of a magnetic recording medium.

### BACKGROUND

In recent years, with advancement of a high-density recording technology in a magnetic disk apparatus, a flying gap between a magnetic head mounted on a magnetic head slider and a magnetic disk, so-called a “head flying height,” tends to be smaller.

Recently, a mechanism that uses a heater or the like located near the magnetic head on the magnetic head slider to deform and cause protrusion of the magnetic head has been employed. The magnetic disk apparatus that includes the magnetic head employing the protrusion mechanism can read and write information from and to a recording medium with high density.

For example, in the conventional technology disclosed in Japanese Laid-open Patent Publication No. 2004-259351, to reduce the flying height of the magnetic head, a heater is provided near the magnetic head and is supplied with electric power to cause protrusion of a magnetic head unit to reduce the gap (the head flying height) between the magnetic head and the disk.

However, the conventional technology described above has a problem in that unstable vibration modes cannot be suppressed, and thus, the head cannot fly stably.

With advancement of a high-density recording technology in a magnetic disk apparatus, the head flying height tends to be smaller in each year. In recent years, the head flying height of about 10 nanometers is required. When the head flying height is made smaller by causing protrusion of the magnetic head unit, a force such as an intermolecular force may occur between a vicinity of the magnetic head and the magnetic disk, causing unstable vibration of the magnetic head slider.

One of the unstable vibration modes is a pitching mode having a vibration node near a gravity center of the magnetic head slider. In this pitching mode, the larger a protrusion amount of the magnetic head becomes, the more likely the vibration occurs. When the head flying height is reduced by increasing the protrusion amount of the magnetic head, the magnetic disk apparatus may have a problem in recording or reproducing function, or the magnetic disk and the magnetic head may be damaged.

To prevent the unstable vibration modes and to permit the slider to more closely follow the disk waviness, a magnetic head slider that applies high air film pressure to an air outflow end of the magnetic head slider is envisaged. However, because the magnetic head unit having the protrusion mechanism is located in the air outflow end, when the air film pressure on the air outflow end is increased, due to the high air film pressure, even with a protruding unit being in its extended state, the gap between the magnetic head and the disk cannot be reduced, in other words, a protrusion efficiency is poor, leading to a problem. The protrusion efficiency refers to a ratio of the gap between the magnetic head and the disk to the protrusion amount.

### SUMMARY

According to an aspect of an embodiment of the present invention, a magnetic head slider includes a magnetic transducer that is mounted on the magnetic head slider and flies over a surface of a magnetic recording medium to read or write information from or to the magnetic recording medium; a front rail having a front ABS (air bearing surface) and a front stepped bearing surface located on an air inflow side from which air flows into the magnetic head slider, the front stepped bearing surface being deeper than the front ABS; a rear rail having a rear ABS and at least one rear stepped bearing surface on an air outflow side from which air flows out from the magnetic head slider, the at least one rear stepped bearing surface being deeper than the rear ABS; and at least one closed vibration attenuation groove formed on the rear ABS of the rear rail with a depth larger than the rear ABS and having the rear stepped bearing surface on the air inflow side.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic cross-sectional view of a magnetic disk apparatus having a magnetic head slider according to a first embodiment;

FIG. 2 is a schematic plane view of the magnetic head slider depicted in FIG. 1;

FIG. 3 is an enlarged view of a portion A of the magnetic head slider depicted in FIG. 2 and a cross-sectional schematic of a shape of the portion A in the partial enlarged view along a line P-Q;

FIG. 4 is a cross-sectional schematic of the magnetic head slider depicted in FIG. 2 along a line R-S;

FIG. 5 is a contour plot of an exemplary protrusion of a surface of the magnetic head unit and an area surrounding the surface on a recording medium side when the magnetic head unit is heated using a heater;

FIG. 6 is a schematic plane view of a conventional magnetic head slider;

FIG. 7 is a cross-sectional schematic of a behavior of a pitching vibration having a vibration node near a gravity center of the conventional magnetic head slider depicted in FIG. 6;

FIG. 8 is a schematic of how a protrusion amount and a flying of an MR element unit change when the conventional magnetic head slider depicted in FIG. 6 is used;

FIG. 9A is a schematic of the magnetic head slider for considering depth;

FIG. 9B is a schematic of a depth consideration result of an attenuation groove;

FIG. 10A is a schematic of the magnetic head slider for considering a position;

FIG. 10B is a schematic of a position consideration result of the attenuation groove;

FIG. 11A is a schematic of the magnetic head slider for considering length;

FIG. 11B is a schematic of a length consideration result of the attenuation groove;

FIG. 12A is a schematic of the magnetic head slider for considering width;

FIG. 12B is a schematic of a width consideration result of the attenuation groove;

FIG. 13A is a schematic plane view of the magnetic head slider according to the first embodiment;

FIG. 13B is a schematic plane view of the conventional magnetic head slider;

FIG. 13C is a schematic of pressure on an inflow-outflow center axis of a rear rail unit;

FIG. 14 is a schematic of a protrusion characteristics comparison result;

FIG. 15 is a schematic of a transfer function comparison result;

FIG. 16A is a schematic of following performance to wave occurred with rotation of a magnetic disk;

FIG. 16B is a schematic of a slider static stability when there is a step in a portion of the magnetic disk;

FIG. 17 is a schematic of an example of the magnetic head slider having a single attenuation groove;

FIG. 18A is a schematic of an example of the magnetic head slider having two stepped surfaces and two attenuation grooves;

FIG. 18B is a schematic of an example of the magnetic head slider having a single stepped surface and two attenuation grooves;

FIG. 19 is a schematic of an example of the magnetic head slider having four attenuation grooves; and

FIG. 20 is a schematic of an example of the magnetic head slider having four attenuation grooves.

### DESCRIPTION OF EMBODIMENTS

Exemplary embodiments of a magnetic head slider and a magnetic disk apparatus according to the present invention are described below in greater detail with reference to the accompanying drawings. An overview of the magnetic head slider and the magnetic disk apparatus according to the present invention, comparison with a conventional technology, effect of the invention, and finally, various variations to the embodiment will be explained in this order.

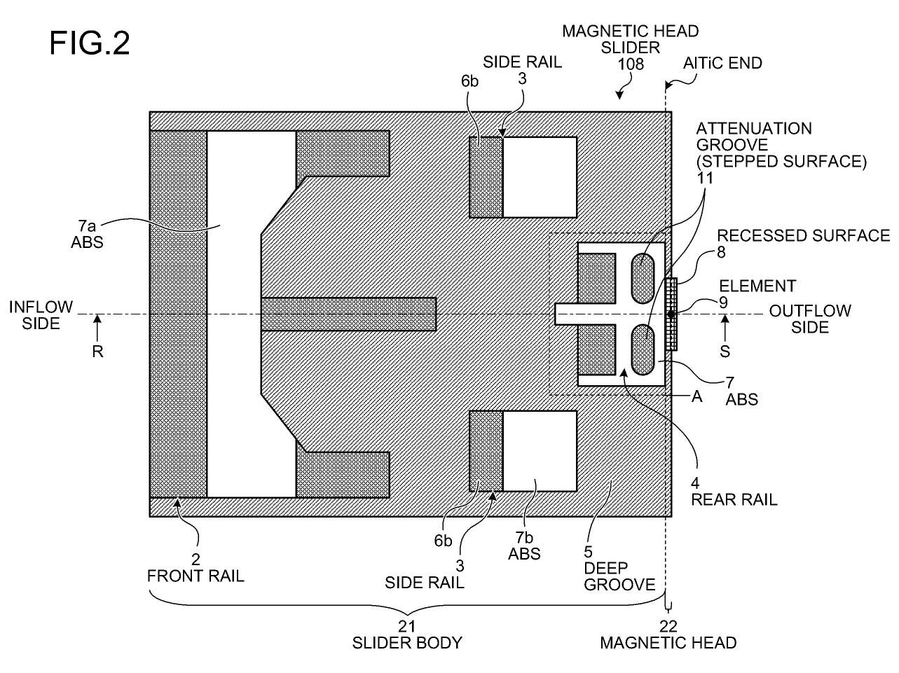

First, an overview of the magnetic head slider disclosed in the present application will be explained. The magnetic head slider according to a first embodiment of the present invention depicted in FIG. 2 includes a closed attenuation groove on a pad provided on the slider having a magnetic head. Information is written or read using the magnetic head heated by a heater and protruded. The magnetic disk apparatus having the magnetic head slider mounted thereon is explained first, and then the magnetic head slider itself is explained.

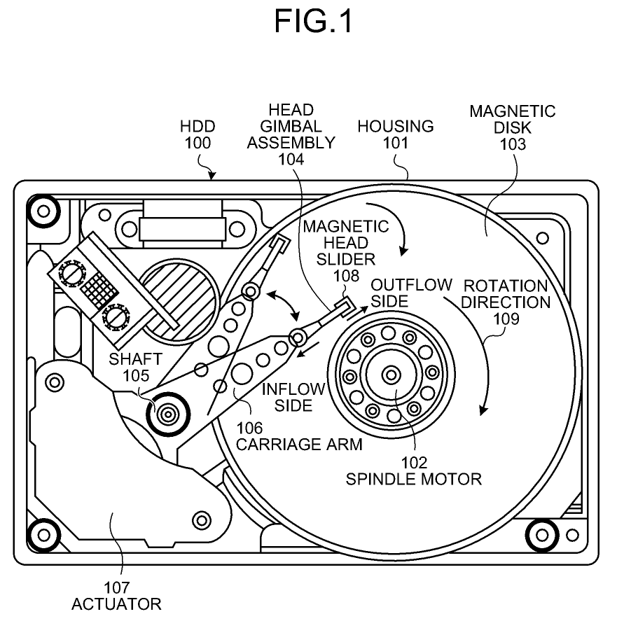

Referring to FIG. 1, the magnetic disk apparatus having the magnetic head slider mounted thereon is explained. FIG. 1 is a schematic cross-sectional view of the magnetic disk apparatus (a hard disk drive (HDD)) having the magnetic head slider according to the first embodiment of the present invention.

As depicted in FIG. 1, a HDD 100 has a housing 101. The housing 101 encloses a magnetic disk 103 and a head gimbal assembly 104. The magnetic disk 103 is attached to a spindle motor 102. The head gimbal assembly 104 has a magnetic head slider 108 mounted thereon with facing to the magnetic disk 103.

The head gimbal assembly 104 having the magnetic head slider 108 according to the first embodiment mounted thereon is fixed to a leading end of a carriage arm 106 which can pivot about a shaft 105. The carriage arm 106 is pivotally driven by an actuator 107 to position the magnetic head slider 108 on a desired recording track on the magnetic disk (recording medium) 103. In this way, the HDD 100 can write or read information to/from the magnetic disk 103.

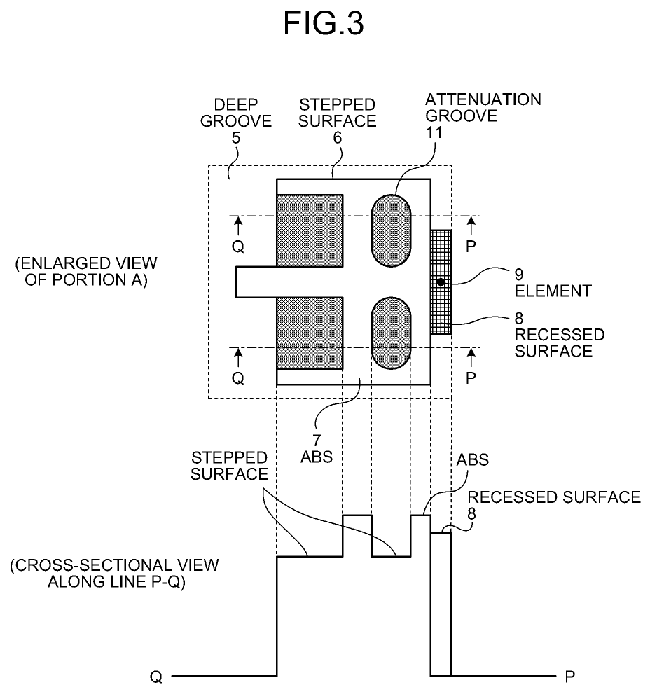

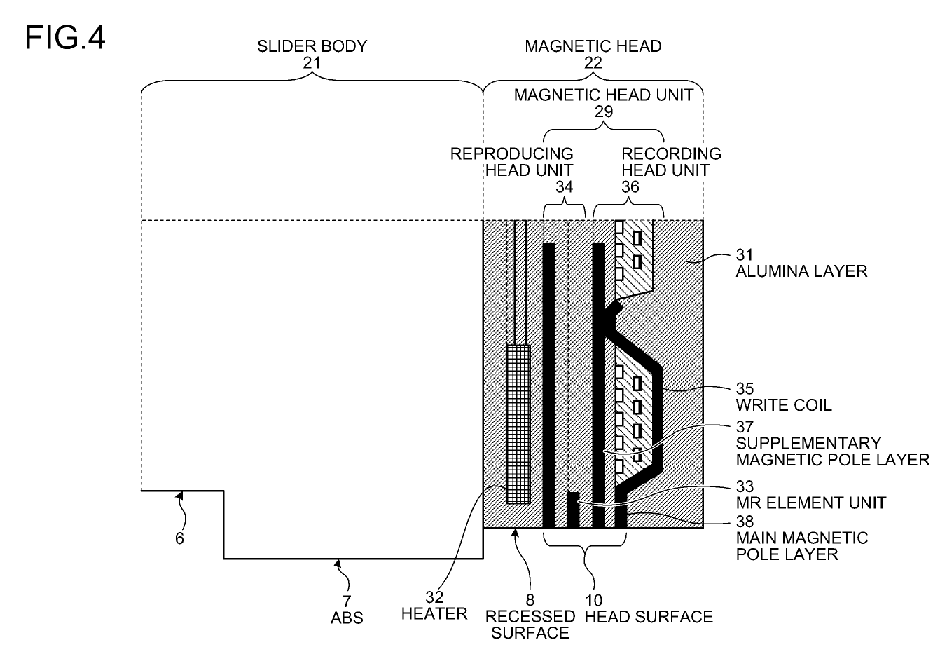

Referring to FIGS. 2 to 4, the magnetic head slider according to the first embodiment is explained. FIG. 2 is a schematic plane view of the magnetic head slider depicted in FIG. 1. In particular, FIG. 2 is a schematic plane view of a surface of the magnetic head slider facing to the recording medium in the magnetic disk apparatus when the magnetic disc apparatus employs the magnetic head slider. FIG. 3 is an enlarged view of a portion A of the magnetic head slider depicted in FIG. 2 and a cross-sectional schematic of a shape of the portion A in the partial enlarged view along a line P-Q. FIG. 4 is a cross-sectional schematic of the magnetic head slider depicted in FIG. 2 along a line R-S.

As depicted in FIG. 2, the magnetic head slider 108 according to the first embodiment has a slider body 21 and a magnetic head 22. The slider body 21 has a front rail 2, side rails 3, and a rear rail 4 located substantially symmetrically about an inflow-outflow center R-S axis. Positive pressure is generated on an ABS (air bearing surface) of each rail (the front rail 2, the side rails 3, and the rear rail 4) to produce buoyant force that allows the magnetic head slider 108 to fly. The slider body 21 has at least the front rail 2 and the rear rail 4 with a deep groove 5 having a depth of, for example, about 1 micrometer to about 4 micrometers. While the side rails 3 are also depicted in FIG. 2, the side rails 3 can be omitted. In addition, the deep groove 5 may have a plurality of steps.

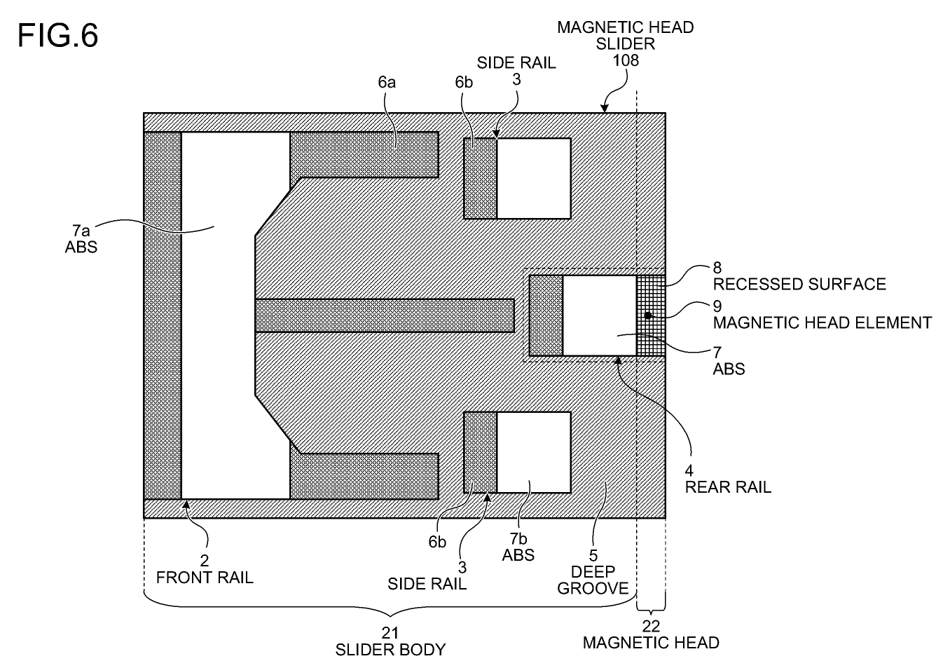

As with a conventional technology, the front rail 2 has a stepped surface 6a (see FIG. 6) and an ABS 7a. Similarly, each of the side rails 3 has a stepped surface 6b and an ABS 7b. Each of the front and side rails has the stepped surface having a depth of, for example, 100 nanometers to 250 nanometers on the inflow side.

The rear rail 4 has, as depicted in FIG. 3, a stepped surface 6 having a depth of 100 nanometers to 250 nanometers, an ABS 7 having no depth, a recessed surface 8, and a magnetic head element 9. Unlike the conventional technology, in addition to those listed above, the rear rail 4 has attenuation grooves 11 having substantially the same depth as the stepped surface 6 on the inflow side. The attenuation grooves 11 are two closed grooves provided substantially symmetrically about the R-S axis on an outflow side of the rear rail 4. The attenuation grooves 11 are located closer to the inflow side than the recessed surface having the magnetic head that reads or writes information from or to the magnetic recording medium. While FIG. 3 shows two grooves, any number of the attenuation grooves may be provided. A trigger to produce positive pressure is generated in the stepped surface 6. Air flows from the inflow side into the attenuation grooves 11 and accumulated therein to suppress vibration. As will be described below, providing the attenuation grooves 11 reduces air film pressure applied on the magnetic head, resulting in improved protrusion efficiency and reduced head flying height, enabling the head to stably fly.

Referring to FIG. 4, an overview of the magnetic head is explained, in parallel with which the attenuation grooves 11 provided on the magnetic head slider according to the first embodiment is explained. As depicted in FIG. 4, the magnetic head slider 108 has the slider body 21 and the magnetic head 22. The magnetic head 22 includes at least a magnetic head unit 29. This magnetic head unit 29 may include a nonmagnetic and nonconductive layer such as alumina layer located around the magnetic head element 9. The magnetic head element 9 is an element provided to record or reproduce information into/from the recording medium within the magnetic disk apparatus. Examples of the magnetic head element 9 include a recording element that functions to write information into the recording medium and a reproducing element such as a magneto-resistance effect (MR) element that functions to read out magnetic information recorded in the recording medium as electric signals. The magnetic head element 9 according to the first embodiment may include either of the recording element or the reproducing element.

The magnetic head 22 has a recording head unit 36 as the recording element. The recording head unit 36 includes a write coil 35, a main magnetic pole layer 38, and a supplementary magnetic pole layer 37. The write coil 35 functions to generate magnetic flux. The main magnetic pole layer 38 functions to contain the magnetic flux generated in the write coil 35 therein to release the magnetic flux toward the magnetic disk (not depicted in FIG. 4). The supplementary magnetic pole layer 37 functions to circulate the magnetic flux released from the main magnetic pole layer 38 via the magnetic disk.

The magnetic head unit 29 of the magnetic head 22 in the magnetic head slider 108 depicted in FIG. 4 includes a reproducing head unit 34 that includes a magneto-resistance effect (MR) element unit 33 as the reproducing element. Note that, the recording head unit 36 and the reproducing head unit 34 may be referred herein collectively to as the magnetic head unit 29. An area surrounding the magnetic head unit 29 is covered with a nonmagnetic and nonconductive alumina layer 31. A heater 32 that contains Cu, NiFe, or the like is provided near the magnetic head unit 29 to heat the magnetic head unit 29. The magnetic head itself is ordinarily structured, thus, the structure thereof will not be explained in detail.

The magnetic head 22 also has the recessed surface 8 facing to the recording medium in the magnetic disk apparatus. The recessed surface 8 includes a surface 10 (hereinafter, referred to as a “head surface 10”) of the magnetic head unit 29 on the recording medium side. The recessed surface 8 forms a single step recessed from the ABS 7. While, in the first embodiment, a height relationship between the recessed surface 8 and the ABS 7 is not specifically constrained, typically, the recessed surface 8 is lower than the ABS 7 by 0.5 nanometers to 3 nanometers at ordinary temperature.

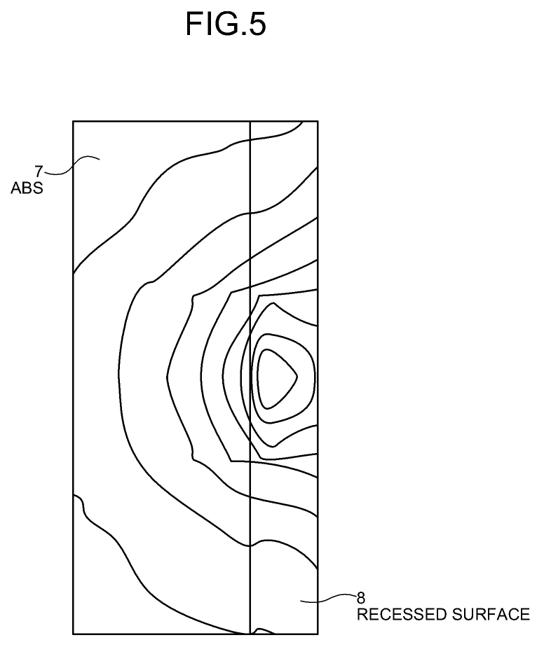

In operation of the magnetic disk apparatus, the magnetic head 22 is heated by the heater 32, causing a surface of the magnetic head unit 29 and the area surrounding the surface on the recording medium side to be thermally expanded and to be protruded toward the recording medium. The head flying height can be controlled by this protrusion amount. FIG. 5 is a contour plot of an exemplary protrusion of the surface of the magnetic head unit 29 and the area surrounding the surface on the recording medium side when the magnetic head unit 29 is heated using the heater 32. As can be seen from FIG. 5, when heated by the heater 32, the protrusion on the recessed surface 8 is largest and tends to become smaller toward the ABS 7. Note that, in FIG. 5, for convenience of explanation, it is assumed that the ABS 7 and the recessed surface 8 have the same height at ordinary temperature. The protrusion amount is largest on the magnetic head unit 29 and becomes smaller as a distance from the magnetic head unit 29 becomes longer. Currently, the protrusion amount is at most about 20 nanometers.

The magnetic head slider 108 according to the first embodiment is compared with a conventional magnetic head slider. In this section, the conventional magnetic head slider used as a comparison target is explained first, then the attenuation groove provided on the magnetic head slider disclosed in the present application is considered, and then a comparison result between the magnetic head slider 108 according to the first embodiment and the conventional magnetic head slider is explained.

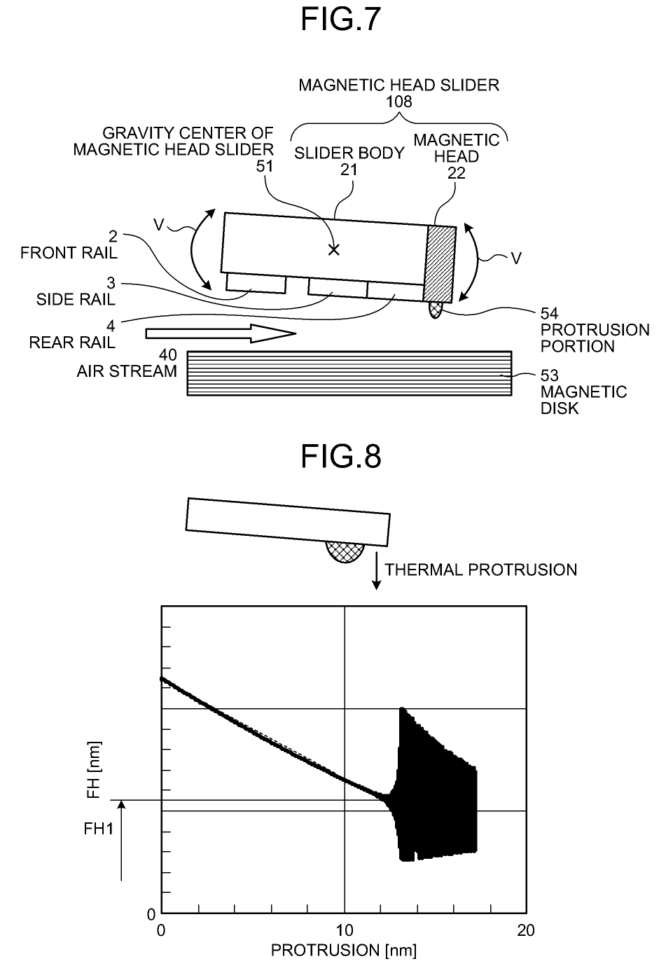

Referring to FIGS. 6 to 8, the conventional magnetic head slider used as the comparison target is explained. FIG. 6 is a schematic plane view of the conventional magnetic head slider. FIG. 7 is a cross-sectional schematic of a behavior of a pitching vibration having a vibration node near a gravity center of the conventional magnetic head slider. FIG. 8 is a schematic of how a protrusion amount and a flying of an MR element unit change when the conventional magnetic head slider depicted in FIG. 6 is used. Note that, FIG. 8 is an analysis result when the magnetic head unit is protruded using the magnetic head slider depicted in FIG. 6.

As depicted in FIG. 6, the conventional magnetic head slider has a similar heater to the magnetic head slider according to the first embodiment depicted in FIG. 2 and is configured to apply high pressure to the outflow end of the magnetic head slider to improve a following performance to a disk. A magnetic head unit including a protruding mechanism is located on the outflow end. Unlike the magnetic disk apparatus disclosed in the present application, the conventional magnetic head slider does not have the attenuation groove 11 on the ABS 7.

As depicted in FIG. 7, in operation of the magnetic disk apparatus, the magnetic head slider 108 flies with aid of an air stream 40 generated by rotation of a magnetic disk 53 with being inclined such that one end having the magnetic head 22 is closer to the magnetic disk 53 than the other end. Pitching vibration V having the vibration node on a gravity center 51 of the magnetic head slider is resulted from an adsorption force generated between the magnetic head 22 surface and a protrusion portion 54 with a protruding surface, and the magnetic disk 53.

As depicted in FIG. 8, when the conventional magnetic head slider is heated by the heater, the protrusion amount becomes larger and thus, the gap (flying height (FH)) to the disk becomes smaller. At a protrusion peak at which a size of the gap reaches to about 6 nanometers, vibration starts to occur. The vibration increases a possibility for the protrusion portion 54 to contact with the magnetic disk, degrading reading and writing capabilities of the magnetic disk apparatus. In addition, due to the vibration, the flying height cannot be further reduced, and therefore, the reading and writing capabilities of the magnetic disk apparatus cannot be improved.

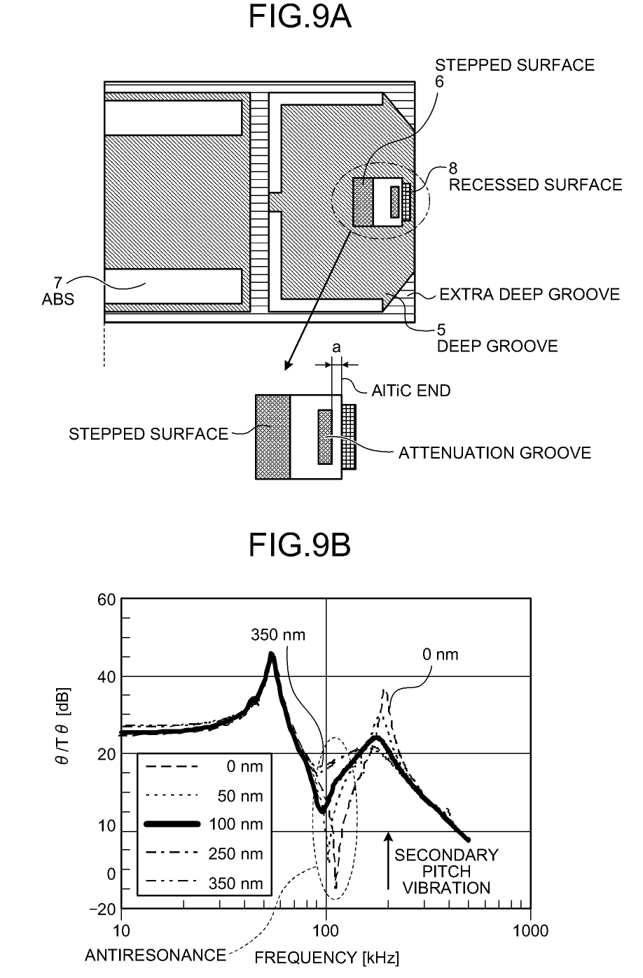

Referring to FIGS. 9A and 9B, a depth of the attenuation groove provided on the magnetic head slider disclosed in the present application is considered. FIG. 9A is a schematic of the magnetic head slider for considering depth. FIG. 9B is a schematic of a depth consideration result of the attenuation groove.

As depicted in FIG. 9A, a schematic magnetic head slider model has a closed attenuation groove on the pad provided on the outflow end. The magnetic head slider includes recessed surfaces, namely the ABS, the stepped surface, a deep groove surface, an extra deep groove surface, the recessed surface, and an attenuation groove surface. With reference to the ABS, the stepped surface has a depth of 170 nanometers, the deep groove surface has a depth of 1.5 micrometers, the extra deep groove surface has a depth of 3 micrometers, and the recessed surface has a depth of 1.5 nanometers. The ABS and the stepped surface are provided on the inflow side with respect to the attenuation groove. The closed single attenuation groove is used in the analysis. The depths of the attenuation groove used in the analysis are 0 nanometer, 50 nanometers, 100 nanometers, 250 nanometers, and 350 nanometers.

In analysis, a pitch torque impulse is applied to the magnetic head slider disclosed in the present application, change in a pitch angle of the magnetic head slider is obtained, and then a transfer function of the pitch angle and the pitch torque is observed. A distance ‘a’ of the attenuation groove from an AlTiC end is 20 micrometers and held constant, and a dimension of the attenuation groove is 20 micrometers by 90 micrometers. The result with changing the attenuation groove depth is represented. As a result, as can be seen from FIG. 9B, when the depth of the attenuation groove is equal to or greater than 100 nanometers, the vibration peak is not substantially changed. When the depth of the attenuation groove is equal to or higher than 250 nanometers, anti-resonance disappears and a gain of the anti-resonance becomes larger, meaning that vibration tends to occur. Consequently, it can be said that the attenuation groove having a depth of about 100 nanometers to 250 nanometers suppresses a resonance peak and prevents the anti-resonance gain from being large. This depth of the attenuation groove is approximately the same as the stepped surface.

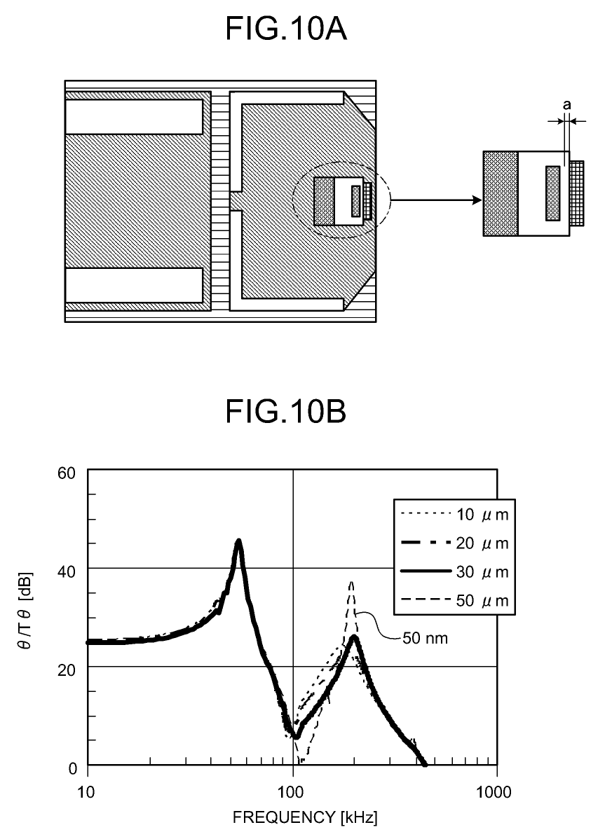

Referring to FIGS. 10A and 10B, a position of the attenuation groove provided on the magnetic head slider disclosed in the present application is considered. FIG. 10A is a schematic of the magnetic head slider for considering a position. FIG. 10B is a schematic of a position consideration result of the attenuation groove.

As depicted in FIG. 10A, as with FIG. 9A, the schematic magnetic head slider model has the closed attenuation groove on the pad provided on the outflow end. The magnetic head slider includes recessed surfaces, namely the ABS, the stepped surface, the deep groove surface, the extra deep groove surface, the recessed surface, and the attenuation groove surface. With reference to the ABS, the stepped surface has a depth of 170 nanometers, the deep groove surface has a depth of 1.5 micrometers, the extra deep groove surface has a depth of 3 micrometers, and the recessed surface has a depth of 1.5 nanometers. The ABS and the stepped surface are provided on the inflow side with respect to the attenuation groove. The closed single attenuation groove is used in the analysis. The depth of the attenuation groove used in the analysis is 100 nanometers and held constant, and the dimension of the attenuation groove is 20 micrometers by 90 micrometers. The distances ‘a’ of the attenuation groove from the AlTiC end used in the analysis are 10 micrometers, 20 micrometers, 30 micrometers, and 50 micrometers.

In analysis, as with the depth consideration, a pitch torque impulse is applied to the magnetic head slider, change in the pitch angle of the magnetic head slider is obtained, and then the transfer function of the pitch angle and the pitch torque is observed. The result with changing the attenuation groove position is represented. As a result, as can be seen from FIG. 10B, when the distance ‘a’ of the attenuation groove is equal to or smaller than 30 micrometers, the vibration peak is suppressed. When the distance ‘a’ of the attenuation groove is 50 micrometers, the vibration peak becomes larger. Consequently, the distance ‘a’ of the attenuation groove should be smaller than 50 micrometers to enable the resonance peak to be suppressed.

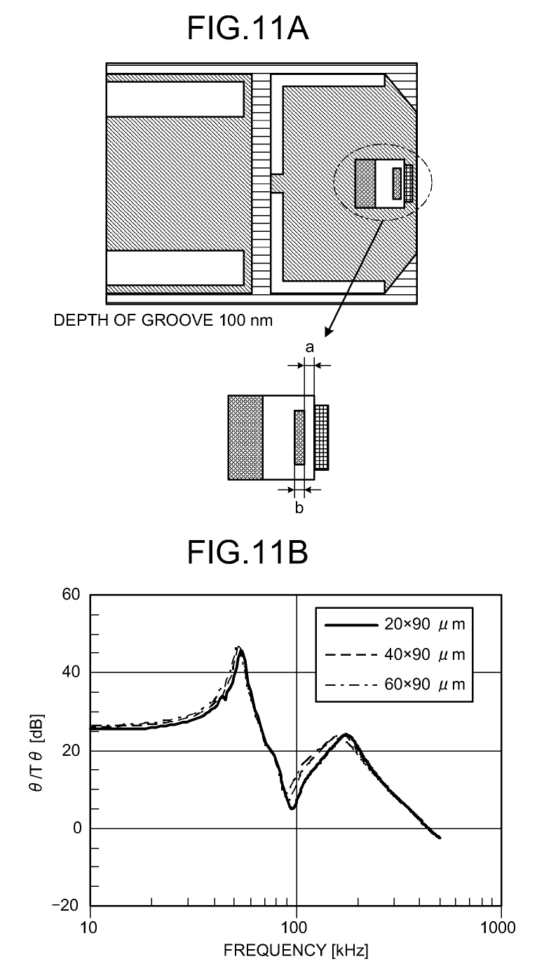

Referring to FIGS. 11A and 11B, a length of the attenuation groove provided on the magnetic head slider disclosed in the present application is considered. FIG. 11A is a schematic of the magnetic head slider for considering a length. FIG. 11B is a schematic of a length consideration result of the attenuation groove.

As depicted in FIG. 11A, as with FIG. 9A, the schematic magnetic head slider model has the closed attenuation groove on the pad provided on the outflow end. The magnetic head slider includes recessed surfaces, namely the ABS, the stepped surface, the deep groove surface, the extra deep groove surface, the recessed surface, and the attenuation groove surface. With reference to the ABS, the stepped surface has a depth of 170 nanometers, the deep groove surface has a depth of 1.5 micrometers, the extra deep groove surface has a depth of 3 micrometers, and the recessed surface has a depth of 1.5 nanometers. The ABS and the stepped surface are provided on the inflow side with respect to the attenuation groove. The closed single attenuation groove is used in the analysis. The width, the distance ‘a’, and the depth of the attenuation groove used in the analysis are 90 micrometers, 20 micrometers, and 100 nanometers, respectively, and are held constant. Lengths ‘b’ of the attenuation groove used in analysis are 20 micrometers, 40 micrometers, and 60 micrometers.

In analysis, as with the depth consideration, the pitch torque impulse is applied to the magnetic head slider, change in the pitch angle of the magnetic head slider is obtained, and then the transfer function of the pitch angle and the pitch torque is observed. The result with changing the attenuation groove length is represented. As a result, as can be seen from FIG. 11B, there is no significant change in the result with changing length, meaning that the attenuation groove can have a minimal length required to form the groove. When the groove is formed using an ion milling process, the required minimal length is equal to or greater than 60 micrometers. When the groove is formed using a reactive ion etching (RIE method) process, the required minimal length is equal to or greater than 20 micrometers.

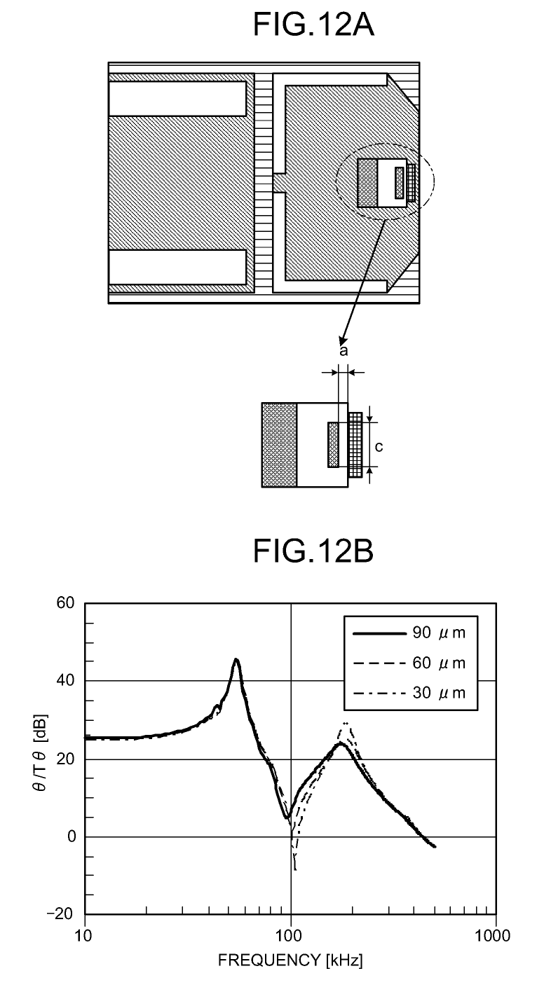

Referring to FIGS. 12A and 12B, a width of the attenuation groove provided on the magnetic head slider disclosed in the present application is considered. FIG. 12A is a schematic of the magnetic head slider for considering a width. FIG. 12B is a schematic of a width consideration result of the attenuation groove.

As depicted in FIG. 12A, as with FIG. 9A, the schematic magnetic head slider model has the closed attenuation groove on the pad provided on the outflow end. The magnetic head slider includes recessed surfaces, namely the ABS, the stepped surface, the deep groove surface, the extra deep groove surface, the recessed surface, and the attenuation groove surface. With reference to the ABS, the stepped surface has a depth of 170 nanometers, the deep groove surface has a depth of 1.5 micrometers, the extra deep groove surface has a depth of 3 micrometers, and the recessed surface has a depth of 1.5 nanometers. The ABS and the stepped surface are provided on the inflow side with respect to the attenuation groove. The closed single attenuation groove is used in the analysis. The length, the distance ‘a’, and the depth of the attenuation groove used in the analysis are 20 micrometers, 20 micrometers, and 100 nanometers, respectively, and are held constant. The attenuation grooves having a width of 90 micrometers, 60 micrometers, and 30 micrometers are analyzed.

In analysis, as with the depth consideration, the pitch torque impulse is applied to the magnetic head slider, change in the pitch angle of the magnetic head slider is obtained, and then the transfer function of the pitch angle and the pitch torque is observed. The result with changing the attenuation groove width is represented. As a result, as can be seen from FIG. 12B, there is no significant change in the result with changing width, meaning that the attenuation groove can have a minimal width required to form the groove. When the groove is formed using an ion milling process, the required minimal width is equal to or greater than 60 micrometers. When the groove is formed using a reactive ion etching process, the required minimal width is equal to or greater than 20 micrometers.

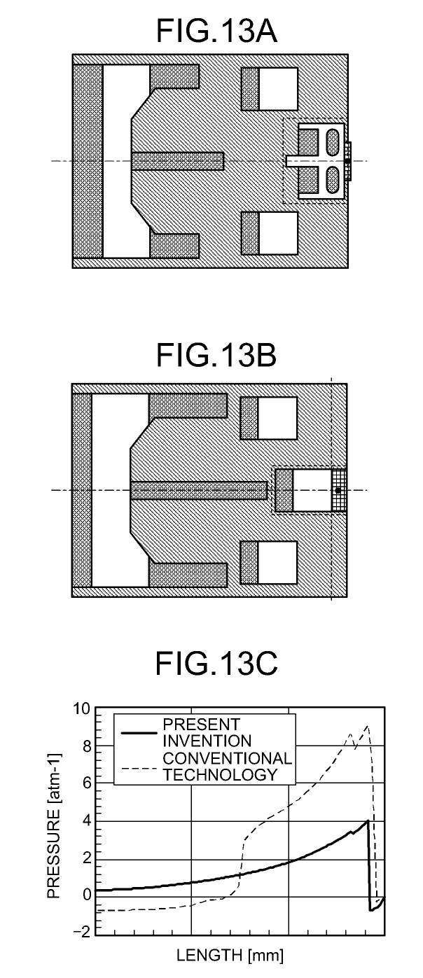

In this section, referring to FIGS. 13A to 16B and based on the consideration results in the above section, comparison results between the magnetic head slider 108 provided with the attenuation groove according to the first embodiment and the conventional magnetic head slider are explained.

According to the first embodiment, the magnetic head slider compared in this section includes the magnetic head, the slider body including the magnetic head, two or more closed attenuation grooves on the pad located on the outflow end of the slider body that are arranged to be substantially symmetrically about the inflow-outflow center axis, and the ABS and the stepped surface on the inflow side of each of the attenuation grooves. The magnetic head slider according to the first embodiment includes recessed surfaces, namely the ABS, the stepped surface, the deep groove surface, the recessed surface, and the attenuation groove surfaces. With reference to the ABS, the stepped surface has a depth of 100 nanometers to 250 nanometers, the deep groove surface has a depth of 1 micrometer to 4 micrometers, and the recessed surface has a depth of 0.5 nanometer to 2 nanometers. The ABS and the stepped surface are provided on the inflow side with respect to the attenuation grooves. The attenuation grooves are arranged to be substantially symmetrically about the inflow-outflow center axis (R-S axis) to reduce pressure near the MR element unit and to increase an attenuation effect of the closed attenuation grooves.

With using such a configuration, referring to FIGS. 13A to 13C, a comparison result of pressure applied to the magnetic head is explained. FIG. 13A is a schematic plane view of the magnetic head slider according to the first embodiment. FIG. 13B is a schematic plane view of the conventional magnetic head slider. FIG. 13C is a schematic of pressure on the inflow-outflow center axis (R-S axis in FIG. 2) of the rear rail.

Based on the result depicted in FIG. 13C and focusing on maximum pressure occurred on the inflow-outflow center axis (R-S axis in FIG. 2), the maximum pressure occurred in the magnetic head slider according to the first embodiment is about one half as large as that occurred in the conventional magnetic head slider. In the magnetic head slider according to the first embodiment, the rear rail 4 on the inflow-outflow center axis (R-S axis) has no stepped surface 6. Therefore, a trigger to produce positive pressure does not generate, and thus, high pressure does not generated near the MR element unit 33. Therefore, pressure near the MR element unit 33 where the heater 32 is located is maintained at a low level, enabling the protrusion efficiency to be improved.

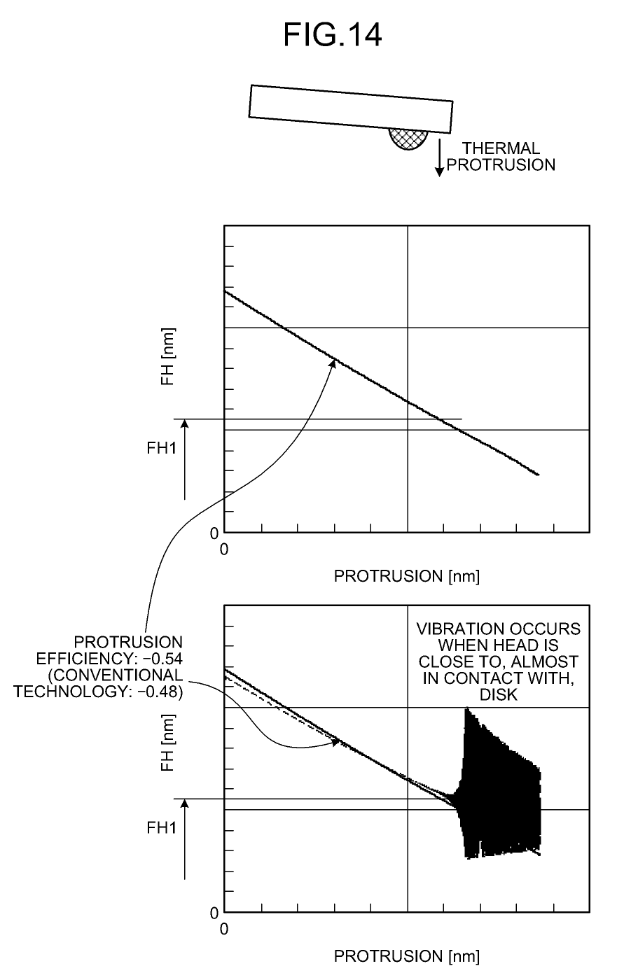

Referring to FIG. 14, protrusion characteristics of the magnetic head when heated by the heater in the magnetic head sliders depicted in FIGS. 13A and 13B are considered. FIG. 14 is a schematic of the protrusion characteristics comparison result.

As depicted in FIG. 14, while, in the conventional magnetic head slider, a vibration occurs when the gap (FH) between the magnetic head and the disk is equal to or smaller than about 6 nanometers, the magnetic head slider according to the first embodiment has no vibration. While a gradient of a line before the vibration occurs (the protrusion efficiency) in the conventional magnetic head slider is 0.48, the gradient in the magnetic head slider according to the first embodiment is 0.52, which means improved protrusion efficiency.

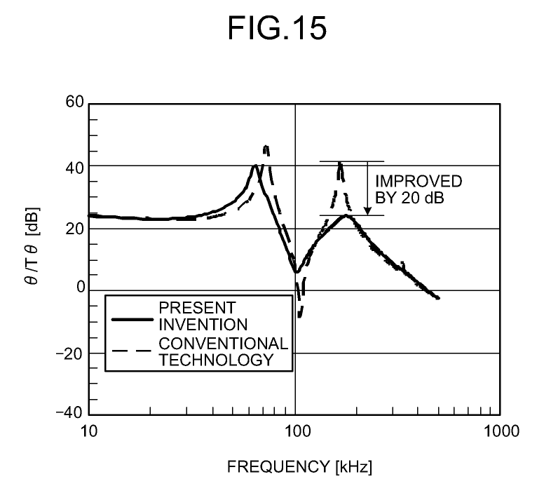

Referring to FIG. 15, the pitch torque impulse is applied to the magnetic head sliders depicted in FIGS. 13A and 13B, change in the pitch angle of the magnetic head slider is obtained, and then the transfer function of the pitch angle and the pitch torque is considered. FIG. 15 is a schematic of the transfer function comparison result.

As depicted in FIG. 15, the magnetic head slider according to the first embodiment exhibits a resonance peak that is lower than the conventional magnetic head slider by 20 dB, which means that vibration suppression is achieved.

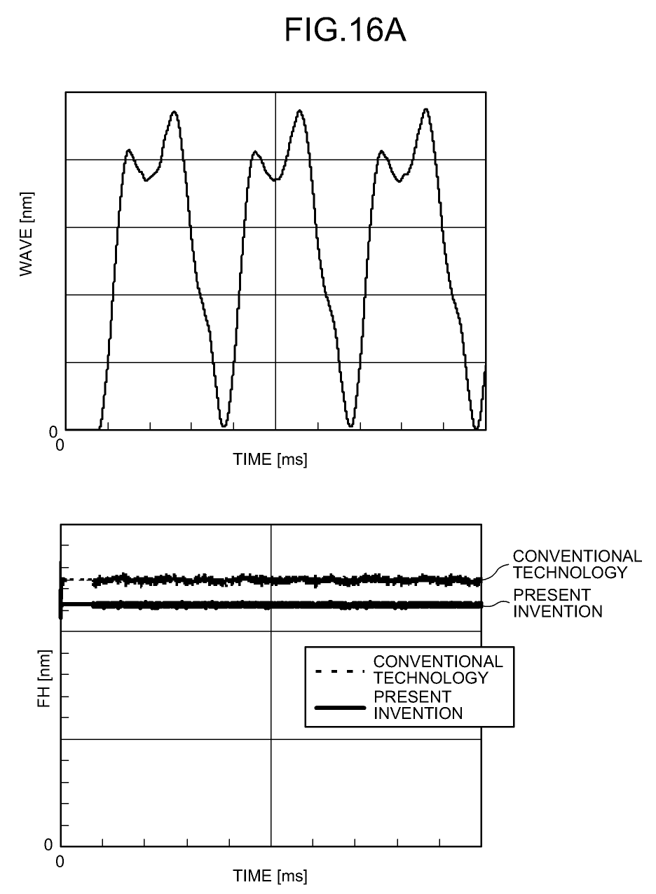

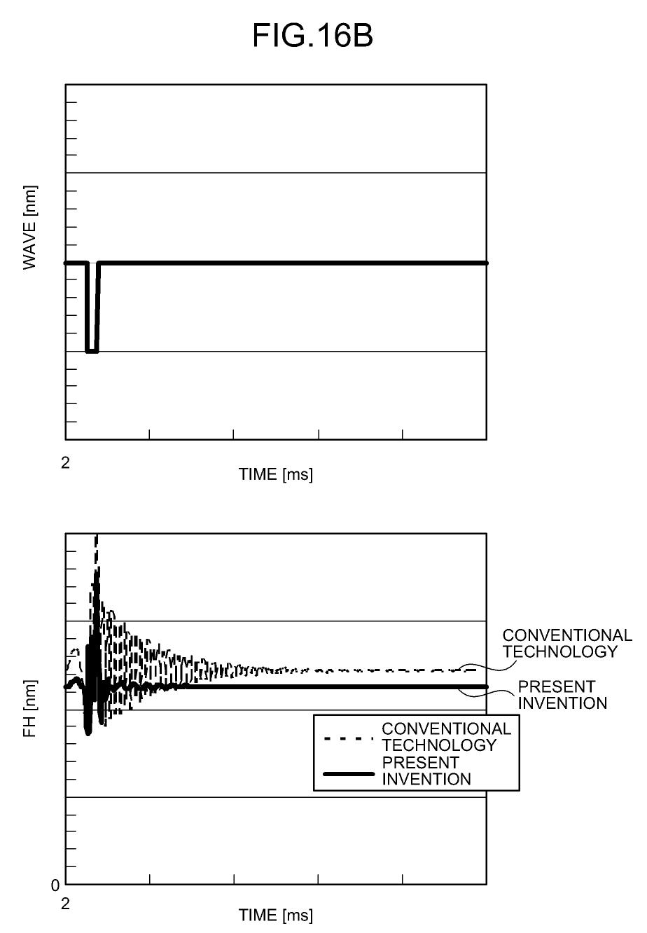

Referring to FIGS. 16A and 16B, a flying fluctuation of the element unit of the magnetic head sliders depicted in FIGS. 13A and 13B with respect to a wave of the magnetic disk is considered. In each schematic, the wave of the disk is depicted in the top and the flying fluctuation of the magnetic head sliders is depicted in the bottom. FIG. 16A is a schematic of following performance to wave occurred with rotation of the magnetic disk. FIG. 16B is a schematic of a slider static stability when there is a recess in a portion of the magnetic disk.

As can be seen from FIGS. 16A and 16B, in both cases, namely, when there is a recess in a portion of the magnetic disk and when the magnetic head slider follows the wave occurred with rotation of the magnetic disk, the magnetic head slider according to the first embodiment represents reduced vibration and flying fluctuation.

In this way, according to the first embodiment, the magnetic disk apparatus includes the magnetic head slider that flies over the surface of the magnetic recording medium to read or write information from or to the magnetic recording medium, the rear rail 4 having the rear ABS and the rear stepped bearing surfaces being deeper than the rear ABS on the air outflow side from which air flows out from the magnetic head slider 108, and at least one closed vibration attenuation groove 11 that is formed on the rear ABS of the rear rail with a depth larger than the rear ABS and has the rear stepped bearing surface on the air inflow side. As a result, the magnetic disk apparatus can suppress unstable vibration mode and allow the magnetic head 22 to fly stably.

In addition, according to the first embodiment, the at least one vibration attenuation groove 11 is positioned on the rear stepped bearing surface that contacts with the air inflow side so as not to intersect the center axis along the longitudinal direction of the magnetic head slider 108, enabling to improve the protrusion efficiency.

Further, according to the first embodiment, the at least one vibration attenuation groove 11 is positioned not to intersect the center axis along the longitudinal direction of the magnetic head slider 108 on the air outflow side of the rear stepped bearing surface, enabling the protrusion efficiency to be further improved.

It may be envisaged that only one closed attenuation groove according to the first embodiment is employed and the depth thereof is increased. However, such a magnetic head slider has increased pressure near the MR element unit 33 due to the protrusion, failing to improve the protrusion efficiency. Alternatively, while it is possible to set the grooves deeper than described herein to increase attenuation, when doing so, the antiresonance component should be taken into account. When the grooves deeper than described herein are used, antiresonance component is removed, making the magnetic head slider to be more vulnerable to disturbance. Conversely, the magnetic disk apparatus 100 described in the first embodiment section takes antiresonance component into account, and therefore, tends not to be influenced by the disturbance. As a result, the magnetic disk apparatus can suppress unstable vibration mode and allow the magnetic head 22 to fly stably.

While, in the first embodiment, the magnetic head slider having two attenuation grooves arranged symmetrically about the inflow-outflow center axis is explained, the present invention is not limited to the embodiment and the attenuation groove(s) can be located in various forms. While the attenuation groove(s) having an ellipsoidal shape is explained below as a second embodiment, the present invention is not limited so and the attenuation groove(s) may take any other shapes such as a substantially triangle, substantially rectangular, or polygonal shape.

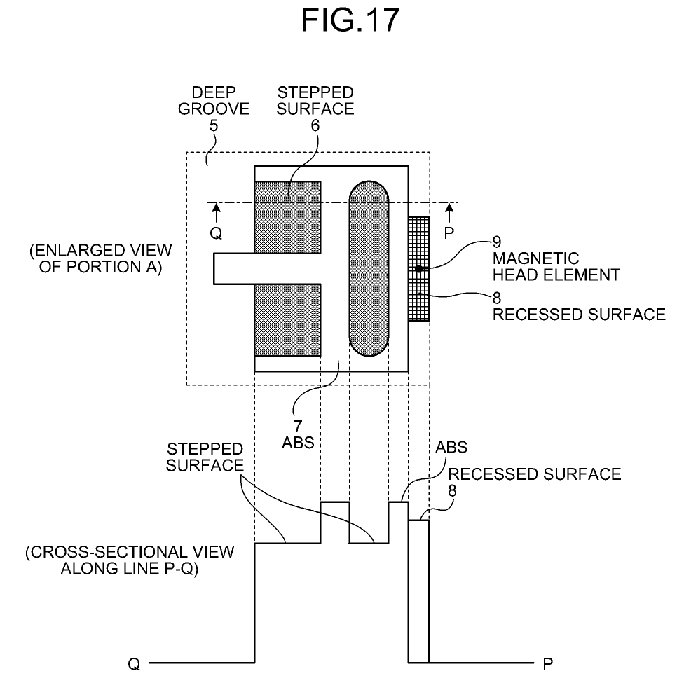

For example, as depicted in FIG. 17, one attenuation groove may be positioned to transverse the inflow-outflow center axis (R-S axis) and two stepped surfaces may be positioned to be substantially symmetrically about the R-S axis on the inflow side of the attenuation groove. In such a configuration, because a trigger to produce positive pressure is generated on the stepped surfaces, large pressure is not produced near the MR element unit 33. In addition, due to the attenuation groove, vibration is suppressed. FIG. 17 is a schematic of an example of the magnetic head slider having a single attenuation groove.

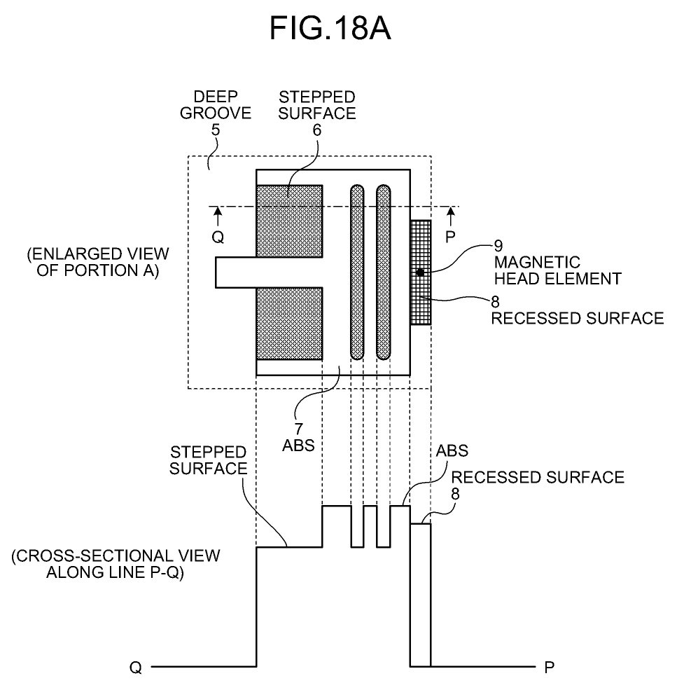

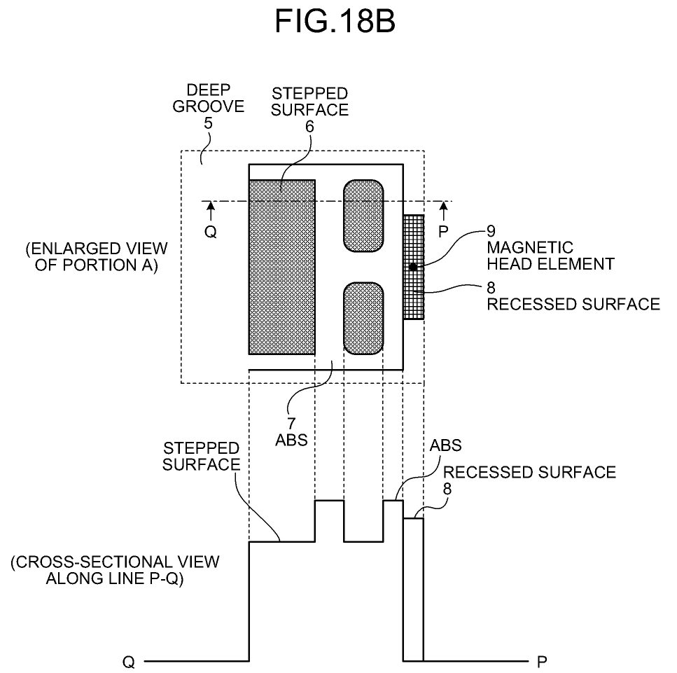

For example, as depicted in FIGS. 18A and 18B, two attenuation grooves may be positioned to transverse the inflow-outflow center axis (R-S axis) along a longitudinal direction of the magnetic head slider. Two stepped surfaces may be positioned to be substantially symmetrically about the R-S axis on the inflow side of the attenuation grooves. In this case, again, because a trigger to produce positive pressure is generated on the stepped surfaces, large pressure is not produced near the MR element unit 33. In addition, due to the attenuation grooves, vibration is suppressed. FIG. 18A is a schematic of an example of the magnetic head slider having two stepped surfaces and two attenuation grooves. FIG. 18B is a schematic of an example of the magnetic head slider having a single stepped surface and two attenuation grooves.

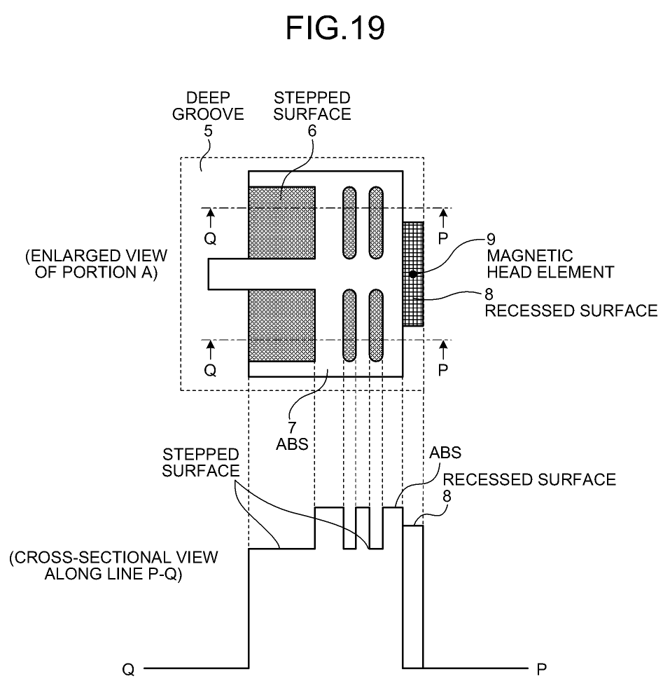

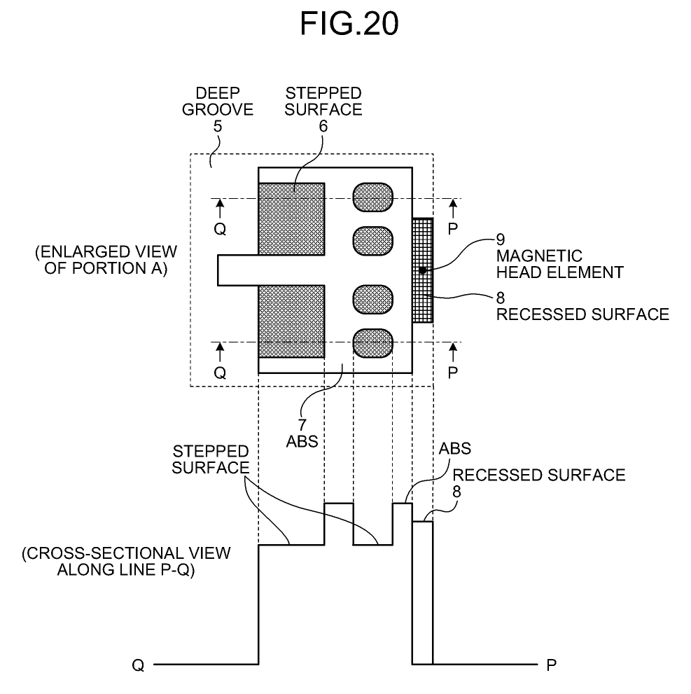

For example, as depicted in FIG. 19, two attenuation grooves may be positioned on each side to be substantially symmetrically about the inflow-outflow center axis (R-S axis) with each attenuation groove on each side being positioned side by side along the longitudinal direction of the magnetic head slider. Two stepped surfaces may be positioned substantially symmetrically about the R-S axis on the inflow side of the attenuation grooves. Alternatively, as depicted in FIG. 20, two attenuation grooves may be positioned on each side to be substantially symmetrically about the inflow-outflow center axis (R-S axis) with each attenuation groove on each side being parallel to the longitudinal direction of the magnetic head slider. Two stepped surfaces may be positioned to be substantially symmetrically about the R-S axis on the inflow side of the attenuation grooves. In these cases, again, because a trigger to produce positive pressure is generated on the stepped surfaces, large pressure is not produced near the MR element unit 33. In addition, due to the attenuation grooves, vibration is suppressed. FIGS. 19 and 20 are schematics of examples of the magnetic head slider having four attenuation grooves.

While the embodiments of the present invention are explained above, the present invention can also be implemented in various different embodiments other than the embodiments described above. The system configuration and others are explained below.

With respect to the system configuration and others, various components of the magnetic disk apparatus depicted in figures are represented in functional and conceptual way and not necessarily required to be physically arranged as depicted in figures. That is, how various devices are particularly distributed or integrated is not limited to those depicted in figures, and therefore, a portion or all of each device can be functionally or physically distributed or integrated in any granularity depending on various load level, usage status, or the like. Similarly, all or any portion of each processing function performed in each device may be embodied as: a controlling device such as a microcontroller unit (MCU), a central processing unit (CPU), or a micro processing unit (MPU); a program interpreted and executed in a controlling device such as a microcontroller unit (MCU), a central processing unit (CPU) or a micro processing unit (MPU); or a hardware with wired logic. In addition, information including a processing procedure, a controlling procedure, concrete terms, and various data and parameters described in the present application and depicted in the accompanying figures can be modified as necessary unless specifically stated otherwise.

According to the embodiments, it is possible to suppress the unstable vibration mode to permit the head to stably fly as well as to improve the protrusion efficiency to readily reduce the gap between the magnetic head and the disk.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A magnetic head slider comprising:
a magnetic transducer that is mounted on the magnetic head slider and flies over a surface of a magnetic recording medium to read or write information from or to the magnetic recording medium;
a front rail having a front ABS (air bearing surface) and a front stepped bearing surface located on an air inflow side from which air flows into the magnetic head slider, the front stepped bearing surface being deeper than the front ABS;
a rear rail having a rear ABS and at least one rear stepped bearing surface on an air outflow side from which air flows out from the magnetic head slider, the at least one rear stepped bearing surface being deeper than the rear ABS; and
at least one closed vibration attenuation groove formed on the rear ABS of the rear rail with a depth larger than the rear ABS and having the rear stepped bearing surface on the air inflow side.

2. The magnetic head slider according to claim 1, wherein the at least one vibration attenuation groove has a substantially same depth as the rear stepped bearing surface.

3. The magnetic head slider according to claim 1, wherein the rear stepped bearing surface and the vibration attenuation groove are located on the rear rail in this order from the air inflow side from which air flows into the magnetic head slider.

4. The magnetic head slider according to claims 1, wherein the at least one rear stepped bearing surface that is in contact with an air inflow end is positioned not to intersect a center axis along a longitudinal direction of the magnetic head slider.

5. The magnetic head slider according to claims 1, wherein the at least one vibration attenuation groove is positioned not to intersect a center axis along a longitudinal direction of the magnetic head slider.

6. The magnetic head slider according to claims 1, wherein the at least one vibration attenuation groove is positioned to be spaced from a rear rail edge of the magnetic head slider toward the air inflow side by a distance smaller than 50 micrometers.

7. The magnetic head slider according to claim 1, wherein the at least one vibration attenuation groove has a width of 20 micrometers or greater.

8. The magnetic head slider according to claim 1, wherein the at least one vibration attenuation groove has a length of 20 micrometers or greater.

9. A magnetic disk apparatus comprising:
a magnetic recording medium that records information;
a slider flying surface facing to the magnetic recording medium;
a magnetic transducer reading or writing information from or to the magnetic recording medium;
a front rail having a front ABS and a front stepped bearing surface on an air inflow side from which air flows into the magnetic head slider, the front stepped bearing surface being deeper than the front ABS;
a rear rail having a rear ABS and a rear stepped bearing surface on an air outflow side, the rear stepped bearing surface being deeper than the rear ABS;
a negative pressure groove positioned between the front rail and the rear rail;
at least one closed vibration attenuation groove that is formed on the rear ABS of the rear rail with a depth larger than the rear ABS and having the rear stepped bearing surface on the air inflow side.
